(19) United States
(12) Patent Application Publication
(10) Pub. No.: US 2012/0302109 A1
(43) Pub. Date: Nov. 29, 2012

(54) ELECTRICAL TERMINAL HAVING A PAIR OF STRENGTHENING ARMS

(75) Inventors: Zhi Cheng Qu, New Taipei (TW); Bing Tao Yang, New Taipei (TW); Yin Lung Wu, New Taipei (TW); Ming Chiang Chen, New Taipei (TW)

(73) Assignee: CHENG UEI PRECISION INDUSTRY CO., LTD., New Taipei City (TW)

(21) Appl. No.: 13/113,323

(22) Filed: May 23, 2011

(51) Int. Cl. H01R 13/02

(52) U.S. Cl. 439/884

(57) ABSTRACT

An electrical terminal has a soldering plate having a front end soldered onto a printed circuit board and a rear end edge bent upward to raise beyond a plane of the soldering plate, an elastic plate extending rearward from a substantial middle of the rear end edge of the soldering plate and inclined upward, a contact portion protruding rearward from a distal end of the elastic plate, and two strengthening arms extending rearward from two ends of the rear end edge of the soldering plate. The strengthening arms are inclined downward and towards the printed circuit board in process of extending rearward, so as to make distal ends thereof resist against the printed circuit board to strengthen the restoring elasticity of the elastic plate, when an external force presses the contact portion and the elastic plate downward.

### BACKGROUND OF THE INVENTION

1. Field of the Invention

The present invention generally relates to an electrical terminal, and more particularly to an electrical terminal having an elasticity.

2. The Related Art

With the development of electronic technology, electronic products are more and more miniaturized. A printed circuit board is often used in the electronic product to realize an electrical connection therebetween by means of electrical terminals. Referring to FIG. 1, a traditional electrical terminal 100′ has a soldering plate 10′ soldered onto the printed circuit board, an elastic plate 20′ extending rearward from a rear end edge of the soldering plate 10′ and inclined upward away from the printed circuit board in process of extending rearward, and a contact portion 21′ defined at a distal end of the elastic plate 20′. When an external force acts on the contact portion 21′ to press the contact portion 21′ towards the printed circuit board, there is only a restoring elasticity produced by the elastic plate 20′ so as to make the electrical terminal 100′ return to an initial state after the contact portion 21′ is set free from the external force. However, the elastic plate 20′ is apt to deform when the contact portion 21′ is pressed downward and set free again and again, on account of the elastic plate 20′ bearing almost all elasticity thereon. Furthermore, the contact portion 21′ is apt to be excessively pressed downward by the external force so that further worsens the deformation of the electrical terminal 100′.

### SUMMARY OF THE INVENTION

An object of the present invention is to provide an electrical terminal adapted to be fixed on a printed circuit board. The electrical terminal has a soldering plate having a front end thereof soldered onto the printed circuit board and a rear end edge thereof bent upward away from the printed circuit board to raise beyond a plane of the soldering plate, an elastic plate extending rearward from a substantial middle of the rear end edge of the soldering plate and inclined upward in process of extending rearward, a contact portion protruding rearward from a distal end of the elastic plate, and a pair of strengthening arms extending rearward from two ends of the rear end edge of the soldering plate. The strengthening arms are inclined downward and towards the printed circuit board in process of extending rearward, so as to make distal ends thereof resist against the printed circuit board to strengthen the restoring elasticity of the elastic plate, when an external force acts on the contact portion to press the contact portion and the elastic plate downward.

As described above, the rear end edge of the soldering plate is away from the printed circuit board and beyond the plane of the soldering plate, to make the two ends thereof capable of extending rearward and inclining towards the printed circuit board to form the pair of strengthening arms. So, when the external force acts on the contact portion to press the contact portion and the elastic plate downward, the distal ends of the strengthening arms can resist against the printed circuit board to strengthen the elasticity of the electrical terminal and provide a greater restoring elasticity for the elastic plate.

### BRIEF DESCRIPTION OF THE DRAWINGS

The present invention will be apparent to those skilled in the art by reading the following description, with reference to the attached drawings, in which:

FIG. 1 is a perspective view of a traditional electrical terminal according to a prior art;

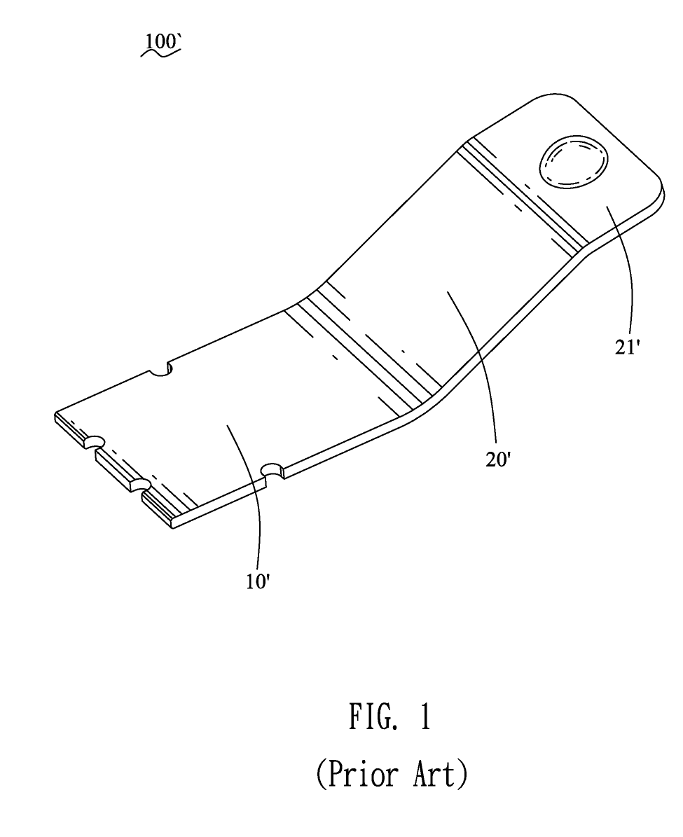

FIG. 2 is a perspective view of an electrical terminal according to an embodiment of the present invention;

FIG. 3 is a perspective view of the electrical terminal of FIG. 2 viewed from another angle;

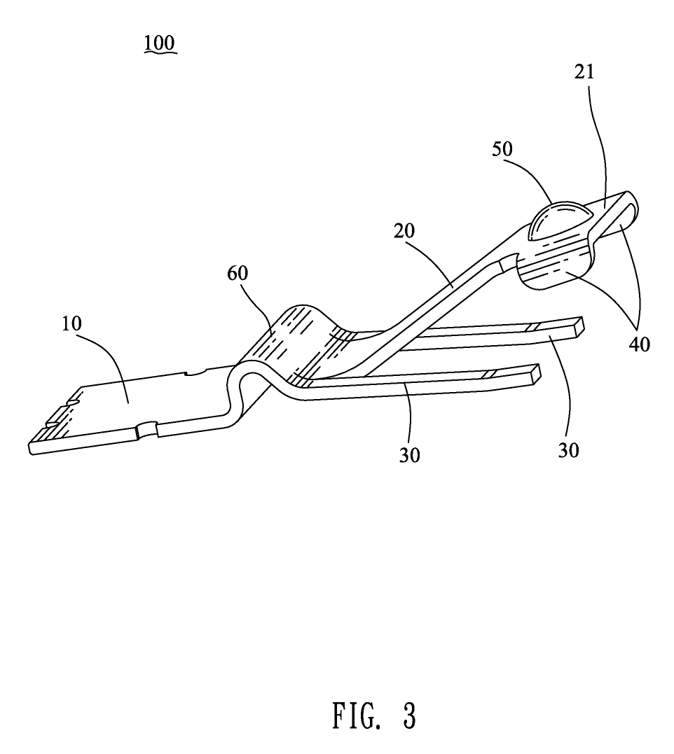

FIG. 4 is a lateral view of the electrical terminal of FIG. 2; and

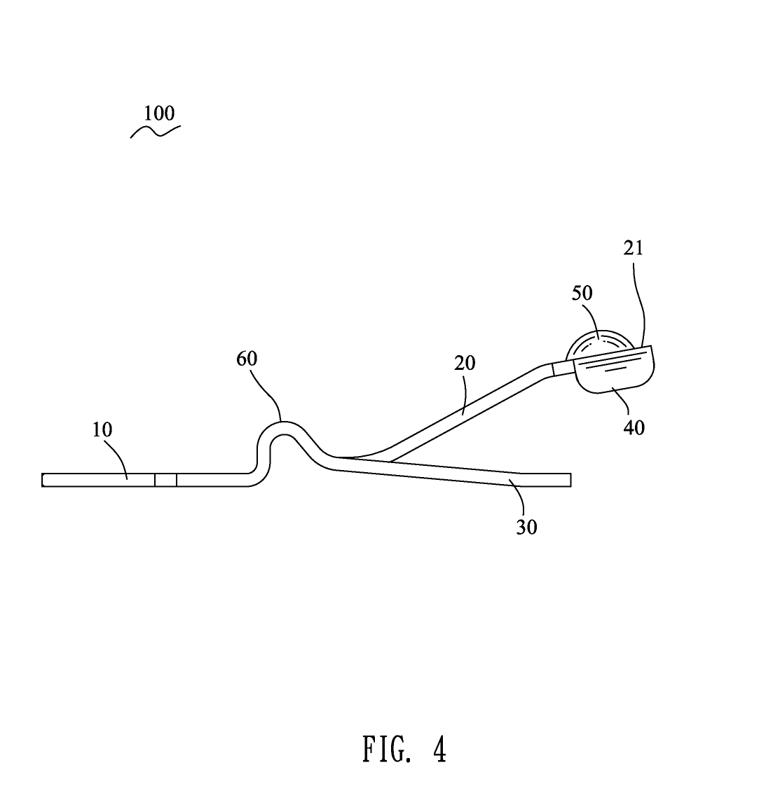

FIG. 5 is a lateral view showing a working state of the electrical terminal of FIG. 2 being pressed downward by an external force.

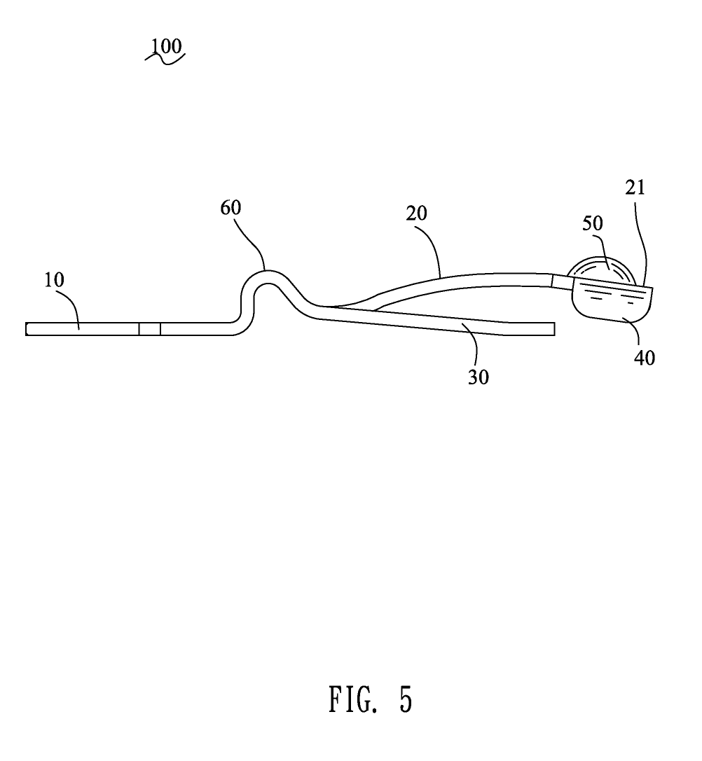

### DETAILED DESCRIPTION OF THE PREFERRED EMBODIMENT

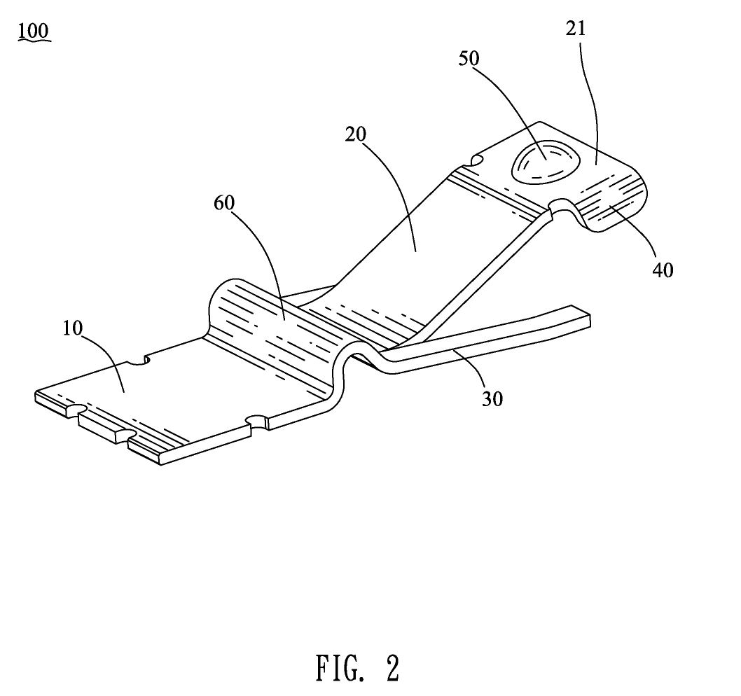

Referring to FIGS. 2˜5, an electrical terminal 100 in accordance with an embodiment of the present invention is shown. The electrical terminal 100 is adapted to be fixed on a printed circuit board (not shown).

The electrical terminal 100 is curved from a metal strip and has a substantially rectangular soldering plate 10, of which a front end is soldered onto the printed circuit board, and a rear end edge is slightly bent upward oppositely to the printed circuit board to raise beyond a plane of the soldering plate 10. A substantial middle of the rear end edge of the soldering plate 10 extends rearward to form an elastic plate 20 inclined upward in process of extending rearward and having a distal end thereof acted as a contact portion 21, wherein the contact portion 21 has a less angle of inclination than that of the elastic plate 20 with respect to the soldering plate 10. A top of the contact portion 21 protrudes upward oppositely to the printed circuit board to form a contact protrusion 50. Two ends of the rear end edge of the soldering plate 10 extend rearward to form a pair of strengthening arms 30 inclined downward and towards the printed circuit board in process of extending rearward, so as to make distal ends thereof resist against the printed circuit board to strengthen the elasticity of the electrical terminal 100, when an external force acts on the contact protrusion 50 of the contact portion 21 to press the contact portion 21 and the elastic plate 20 downward.

In this embodiment, the strengthening arms 30 are adjacent to two opposite side edges of the elastic plate 20, and designed with the elastic plate 20 as an unity. The distal end of each strengthening arm 30 is bent to levelly extend rearward to strengthen the resistance of the strengthening arm 30 against the printed circuit board.

In this embodiment, two opposite sides of the contact portion 21 are bent downward and towards the printed circuit board to form a resisting flange 40 respectively capable of resisting against the printed circuit board to avoid the contact portion 21 being excessively pressed downward, when the contact portion 21 is pressed downward to a certain extent.

In this embodiment, a rear end of the soldering plate 10 is arched upward away from the printed circuit board to form an arch bridge 60 seen from a lateral view and adjacent to the elastic plate 20, wherein the arch bridge 60 can effectively prevent melted tin solder from flowing onto the elastic plate 20 and the strengthening arms 30, when the soldering plate 10 is soldered with the printed circuit board.

As described above, the rear end edge of the soldering plate 10 is away from the printed circuit board and beyond the plane of the soldering plate 10, to make the two ends thereof capable of extending rearward and inclining towards the printed circuit board to form the pair of strengthening arms 30. So, when the external force acts on the contact protrusion 50 of the contact portion 21 to press the contact portion 21 and the elastic plate 20 downward, the distal ends of the strengthening arms 30 can resist against the printed circuit board to strengthen the elasticity of the electrical terminal 100 and provide a greater restoring elasticity for the elastic plate 20.

What is claimed is:

1. An electrical terminal adapted to be fixed on a printed circuit board, comprising:
a soldering plate having a front end thereof soldered onto the printed circuit board, and a rear end edge thereof bent upward away from the printed circuit board to raise beyond a plane of the soldering plate;
an elastic plate extending rearward from a substantial middle of the rear end edge of the soldering plate and inclined upward in process of extending rearward;
a contact portion protruding rearward from a distal end of the elastic plate; and
a pair of strengthening arms extending rearward from two ends of the rear end edge of the soldering plate, wherein the strengthening arms are inclined downward and towards the printed circuit board in process of extending rearward, so as to make distal ends thereof resist against the printed circuit board to strengthen the restoring elasticity of the elastic plate, when an external force acts on the contact portion to press the contact portion and the elastic plate downward.

2. The electrical terminal as claimed in claim 1, wherein the strengthening arms are adjacent to two opposite sides of the elastic plate, and designed with the elastic plate as an unity.

3. The electrical terminal as claimed in claim 2, wherein the distal end of each strengthening arm is bent to levelly extend rearward to strengthen the resistance of the strengthening arm against the printed circuit board.

4. The electrical terminal as claimed in claim 1, wherein two opposite sides of the contact portion are bent downward and towards the printed circuit board to form a resisting flange respectively capable of resisting against the printed circuit board to avoid the contact portion being excessively pressed downward.

5. The electrical terminal as claimed in claim 1, wherein a rear end of the soldering plate is arched upward away from the printed circuit board to form an arch bridge seen from a lateral view and adjacent to the elastic plate.

6. The electrical terminal as claimed in claim 1, wherein the contact portion has a less angle of inclination than that of the elastic plate with respect to the soldering plate, a top of the contact portion protrudes upward oppositely to the printed circuit board to form a contact protrusion.
